(19) United States
(12) Patent Application Publication
(10) Pub. No.: US 2017/0135119 A1
(43) Pub. Date: May 11, 2017

(54) BASE STATION, SERVER, SYSTEM AND WIRELESS RESOURCE ALLOCATION METHOD

(71) Applicant: NEC Corporation, Minato-ku, Tokyo (JP)

(72) Inventor: Takehiro SUZUKI, Tokyo (JP)

(73) Assignee: NEC Corporation, Minato-ku, Tokyo (JP)

(21) Appl. No.: 15/319,146

(22) PCT Filed: Jun. 19, 2015
(86) PCT No.: PCT/JP2015/003081

§ 371 Date: Dec. 15, 2016

(30) Foreign Application Priority Data
Jun. 27, 2014 (JP) 2014-131961

(51) Int. Cl. H04W 72/10; H04W 76/02

(52) U.S. Cl. CPC H04W 72/10; H04W 76/02

(57) ABSTRACT

In order to resolve the problem of various MVNOs being unable to always fairly share wireless resources of a mobile line network (wireless resources of all base stations), this system has base stations connected to a server, and when wireless resource use amounts related to prescribed groups (MVNO) are input from at least one base station, the server outputs, as information indicating the priority order of the groups, information corresponding to a prescribed number having a monotonic increase relationship with the sum of the use amount related to the group, for each of the groups. When the information indicating the priority order of the groups is input, the base station communicates with terminals by using the wireless resources in order from a terminal of the group with the highest priority indicated by the information.

### TECHNICAL FIELD

The present invention relates to a base station, a server, a system, and a wireless resource allocation method, and in particular, to a base station, a server, a system, and a wireless resource allocation method wherein wireless resources are shared by a plurality of operators.

### BACKGROUND ART

A Mobile Virtual Network Operator (hereafter denoted as an “MVNO”) is generally known. The MVNO is referred to as an operator who provides a mobile communication service by renting a mobile network from a mobile network operator (hereafter denoted as an “MNO”).

A technology relating to the MVNO is disclosed in Patent Literature 1 (PTL 1) described below.

An information processing device of PTL 1 comprises a calculation unit. The calculation unit calculates a use fee to be charged to a network operator (that is, an MVNO) providing a wireless communication service by the use of a mobile network owned by an MNO. There, the calculation unit performs the use fee calculation on the basis of a parameter which is dependent on the efficiency of wireless resource usage.

Because the information processing device of PTL 1 calculates a use fee of an MVNO in accordance with the efficiency of wireless resource usage, the MVNO is motivated to use the wireless resources efficiently. As a result, the MVNO's efficient use of the wireless resources is promoted, and the information processing device of PTL 1 accordingly can prevent the limited wireless resources from being used up or being tight.

Incidentally, it is general that, when an MVNO makes a contract with an MNO for use of the MNO's mobile network, the MVNO uses the mobile network in a manner of sharing it with other MVNOs. In that case, the MVNOs also share wireless resources used by base stations provided in the mobile network for their performing wireless communication with each other. For example, the wireless resources are frequency bands. FIG. 1 is a diagram showing an example of wireless resources (frequency bands) used by a general base station. As shown in FIG. 1, MVNOs share the wireless resources (frequency bands) #1 to #16 which the base station uses for performing wireless communication. In the present description, such wireless resources used by a base station is hereafter referred to as “wireless resources of a base station”.

As one of methods by which MVNOs share wireless resources of a base station, there is known a method in which, as shown in FIG. 1, the wireless resources are classified into dedicated wireless resources for exclusive use by respective MVNOs and shared wireless resources for shared use by the MVNOs and MVNOs share the shared wireless resources. In the method, each MVNO first uses wireless resources dedicated to the MVNO (hereafter referred to as “dedicated resources”) and, when having already used up all of the dedicated wireless resources, it then uses the shared wireless resources. There, while each of the MVNOs can secure wireless resources it can use any time, it also can use other wireless resources in a manner of sharing them with the other MVNOs.

To implement the method, on its receiving a message for requesting a connection from a terminal of an MVNO, each base station provided in the mobile network performs communication with the terminal of the MVNO by using the dedicated resources of the MVNO. Then, when it has already used up all the dedicated resources of the MVNO, each base station uses the shared wireless resources and performs communication with a terminal of the MVNO. The shared wireless resources provided in each base station thus become used by each MVNO (its terminals).

Patent Literature 2 (PTL 2) and Patent Literature 3 (PTL 3) describe devices which provide a service or manage the service quality by using resources.

### CITATION LIST

### Patent Literature

[PTL1] International Patent Publication No. WO 2013/132901

[PTL2] Japanese Patent Laid-Open No. JP 2011-044799

[PTL3] Published Japanese translation of PCT application No. 2005-539462

### SUMMARY OF INVENTION

### Technical Problem

However, in general mobile communication systems including the devices of PTL 1, PTL 2 and PTL 3 (hereafter collectively referred to as a “mobile communication system of PTL 1”), there has been a problem in that it is not necessarily possible for MVNOs to fairly share wireless resources of each base station provided in the mobile network.

It is because, each base station in the mobile communication systems of PTL 1, PTL 2 and PTL 3 uses the shared wireless resources of the base station without determining which MVNO's terminals are currently using a larger number of the wireless resources of base stations, when it uses the shared wireless resources. As a result, a large number of shared wireless resources of each base station may be used by terminals of some of the MVNOs, and it consequently has not been necessarily possible for the MVNOs to fairly share the wireless resources of each base station.

Because of arising of the above-described problem, users of terminals of each MVNO may have an impression that a telephone call is easily connected from terminals of some MVNO but is not from terminals of other MVNOs, and accordingly the MVNOs may be forced to unfairly compete with each other.

The present invention aims to provide a base station, a server, a system, and a wireless resource allocation method that solves the above-described problems.

### Solution to Problem

To achieve the above-described object, a base station of the present invention comprises: a wireless resource usage means for, on receiving a connection request message from a terminal of one of predetermined groups, performing communication with the terminal by using wireless resources for communication; and a reporting means for, at predetermined timing, outputting, in terms of each of the groups, the usage amount of the wireless resources used for performing communication with terminals of the predetermined group, wherein if information indicating a priority order of the groups is inputted to the wireless resource usage means in response to the output, when communicating with the terminals after that, the wireless resource usage means performs the communication with the terminals by using the wireless resources in order from the terminal of the group having a highest position in the priority order indicated by the information.

To achieve the above-described object, a server of the present invention comprises a determination means for, on receiving the amount of wireless resource usage related to each predetermined group inputted from at least one of base stations connected to the server, outputting, in terms of each of the groups, information corresponding to a predetermined number which is in a monotonically increasing relation with the total of the amounts of wireless resource usage related to the group, as information indicating a position of the group in a priority order.

To achieve the above-described objective, a system of the present invention is that in which a base station is connected with a server, wherein:

the base station comprises a wireless resource usage means which, on receiving a connection request message from a terminal of one of predetermined groups, communicates with the terminal by using wireless resources for performing communication, and a reporting means which, at predetermined timing, in terms of each of the groups, outputs the amount of wireless resource usage for performing communication with terminals of the predetermined group, wherein

if information indicating a priority order of the groups in response to the output is inputted, when communicating with the terminals after that, the wireless resource usage means performs the communication with the terminals by using the wireless resources in order from the terminal of the group having a highest position in the priority order indicated by the information; and

the server comprises a determination means which, when the amount of wireless resource usage related to each of the predetermined groups is inputted from at least one of base stations connected to the server, outputs, in terms of each of the groups, information corresponding to a predetermined number which is in a monotonically increasing relation with the total of the amounts of usage related to the group, as information indicating a position of the group in the priority order.

To achieve the above-described object, a wireless resource usage method of the present invention comprises: on receiving the amount of wireless resource usage related to each predetermined group inputted from at least one of base stations, outputting, in terms of each of the groups, information corresponding to a predetermined number which is in a monotonically increasing relation with the total of the amounts of wireless resource usage related to the group, as information indicating a position of the group in a priority order; and

when communicating with terminals of the groups, each of the base stations performing the communication with the terminals by using its wireless resources in order from the terminal of the group having a highest position in the priority order indicated by the inputted information.

### Advantageous Effects of Invention

According to the present invention, MVNOs can share wireless resources of base stations in a mobile network more fairly.

### BRIEF DESCRIPTION OF DRAWINGS

FIG. 1 is a diagram showing an example of wireless resources (frequency bands) used by a general base station.

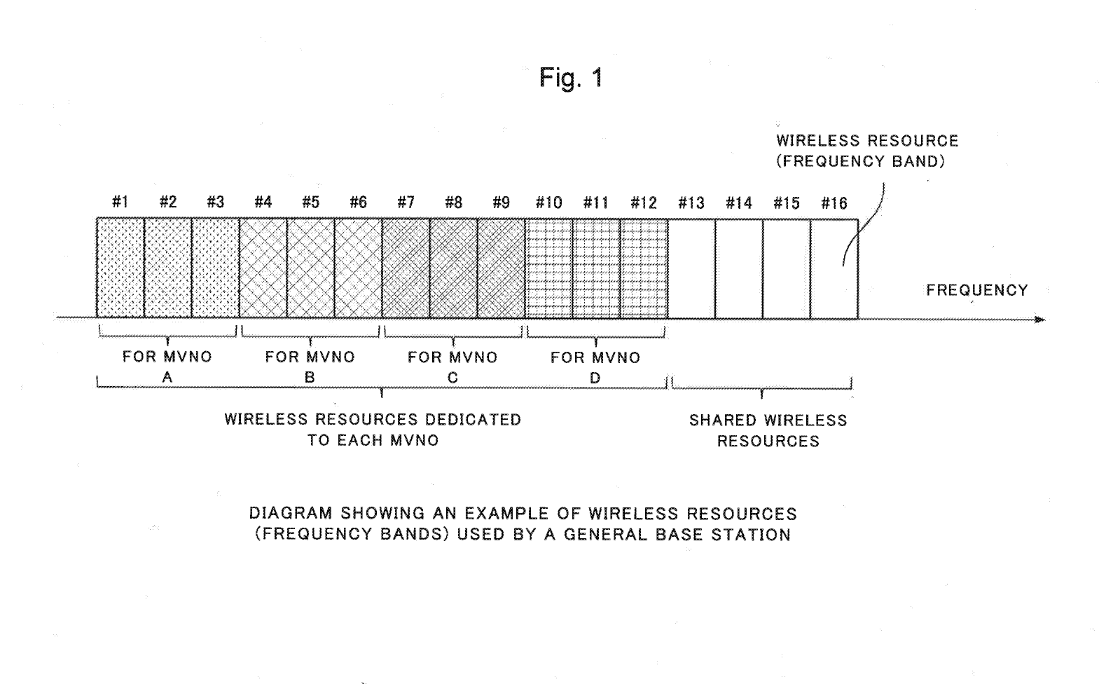

FIG. 2 is a diagram showing an example of a configuration of a system in a first exemplary embodiment of the present invention.

FIG. 3 is a diagram showing an example of wireless resources used by a base station in the system in the first exemplary embodiment of the present invention.

FIG. 4 is a diagram showing an example of a configuration of a base station in the system in the first exemplary embodiment of the present invention.

FIG. 5 is a diagram showing an example of a configuration of a server in the system in the first exemplary embodiment of the present invention.

FIG. 6 is a diagram for explaining operation (whole operation) of the system in the first exemplary embodiment of the present invention.

FIG. 7 is a diagram for explaining operation (operation performed in an Attach procedure) of the system in the first exemplary embodiment of the present invention.

FIG. 8 is a diagram for explaining wireless resources provided in a base station in the system in the first exemplary embodiment of the present invention.

FIG. 9 is a diagram for explaining operation (performed by a server) of the system in the first exemplary embodiment of the present invention.

FIG. 10 is a diagram showing an example of information (a proportion of wireless resource usage by each MVNO (Mobile Virtual Network Operator) out of all wireless resources) which is stored in the server provided in the system in the first exemplary embodiment of the present invention.

FIG. 11 is a diagram showing an example of information (a position of each MVNO in a usage priority order) which is sent and received within the server provided in the system in the first exemplary embodiment of the present invention.

FIG. 12 is a diagram for explaining operation (of a base station after being notified of a usage priority order) of the system in the first exemplary embodiment of the present invention (part 1).

FIG. 13 is a diagram for explaining operation (of a base station after being notified of a usage priority order) of the system in the first exemplary embodiment of the present invention (part 2).

FIG. 14 is a diagram showing an example of information (MVNO information and wireless resource usage rate) which is stored in the server provided in the system in the first exemplary embodiment of the present invention.

FIG. 15 is a diagram showing an example of a configuration of a system in a second exemplary embodiment of the present invention.

FIG. 16 is a diagram for explaining wireless resources used by a base station in the system in the second exemplary embodiment of the present invention.

### DESCRIPTION OF EMBODIMENTS

Next, exemplary embodiments of the present invention will be described in detail, with reference to drawings.

### First Exemplary Embodiment

### [Overview]

In a system in a first exemplary embodiment of the present invention, a server grasps a status of wireless resource usage, that is, what proportion of all of wireless resources provided in base stations connected with the server (hereafter referred to as “all wireless resources”) is currently used by each MVNO. Then, the server determines a usage priority order of the MVNOs such that the MVNOs averagely use all wireless resources. Specifically, the server determines an MVNO currently using a smaller portion of all wireless resources to be an MVNO to be given a higher position in the usage priority order, and an MVNO currently using a larger portion of all wireless resources to be an MVNO to be given a lower position in the usage priority order. Each base station enables an MVNO having been given a higher position in the usage priority to preferentially use its wireless resources shared by the MNVOs (hereafter referred to as “shared resources”).

In the system of the present exemplary embodiment, because each base station thus enables an MVNO currently using a smaller portion of all wireless resources of the base stations to preferentially use the shared resources of the base station, the MVNOs can share all wireless resources of the base stations more fairly.

Hereinafter, details of a configuration, functions and operation of the system in the first exemplary embodiment of the present invention will be described.

[Description of Configuration]

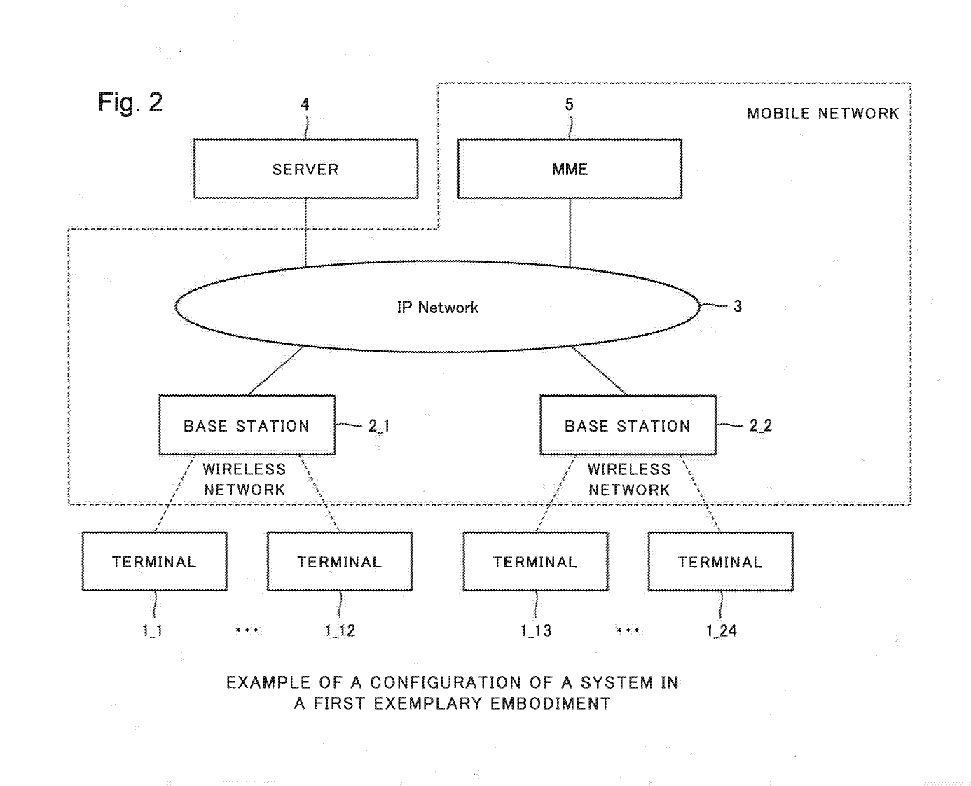

First, a configuration and functions of the system in the first exemplary embodiment of the present invention will be described. FIG. 2 is a diagram showing an example of a configuration of the system in the first exemplary embodiment of the present invention.

(1) Configuration of the System in the First Exemplary Embodiment of the Present Invention

The system of the present exemplary embodiment is a mobile communication system, which comprises, as shown in FIG. 2, terminals 1_k (k=1 to 24), base stations 2_1 and 2_2, an IP network 3, a server 4 and an MME 5. IP is an abbreviation of Internet Protocol, and MME is an abbreviation of Mobility Management Entity.

The terminals 1_1 to 1_12 are connected with the base station 2_1 via a wireless network, and the terminals 1_13 to 1_24 are connected with the base station 2_2 via a wireless network. The base stations 2_1 and 2_2 are connected with the server 4 and the MME 5 via the IP network 3 by wired lines.

Here, the numbers of base stations and terminals comprised in the system of the present exemplary embodiment are not limited to 2 and 24, respectively. In the system of the present exemplary embodiment, more or less than two base stations and more or less than twenty-four terminals may be comprised.

(2) Functions of Terminals 1_k (k=1 to 24)

The terminals 1_k (k=1 to 24) each are general terminals using an MVNO, and operate in conformity with 3GPP (3rd Generation Partnership Project).

In each of the terminals 1_k (k=1 to 24), a SIM (Subscriber Identity Module) card is installed by the user. In the SIM card, information indicating an MVNO (hereafter referred to as “MVNO information”) has been written. The SIM card is a card which is provided by the MVNO when the user of the terminal 1_k makes a contract with the MVNO, and into which the above-mentioned MVNO information is written by the MVNO.

When sending a general message for requesting a connection, the terminal 1_k (k=1 to 24) sends also the above-mentioned MVNO information by including it in the message. It is in order to inform the base station 2_1 or 2_2 of a terminal using which MVNO the terminal 1_k (k=1 to 24) is (hereafter, a terminal using a certain MVNO is referred to as a “terminal of the MVNO”). Here, the above-mentioned message for requesting a call connection may be RRC Connection Request specified in 3GPP. RRC is an abbreviation of Radio Resource Control.

(3) Functions of the Base Stations 2_1 and 2_2

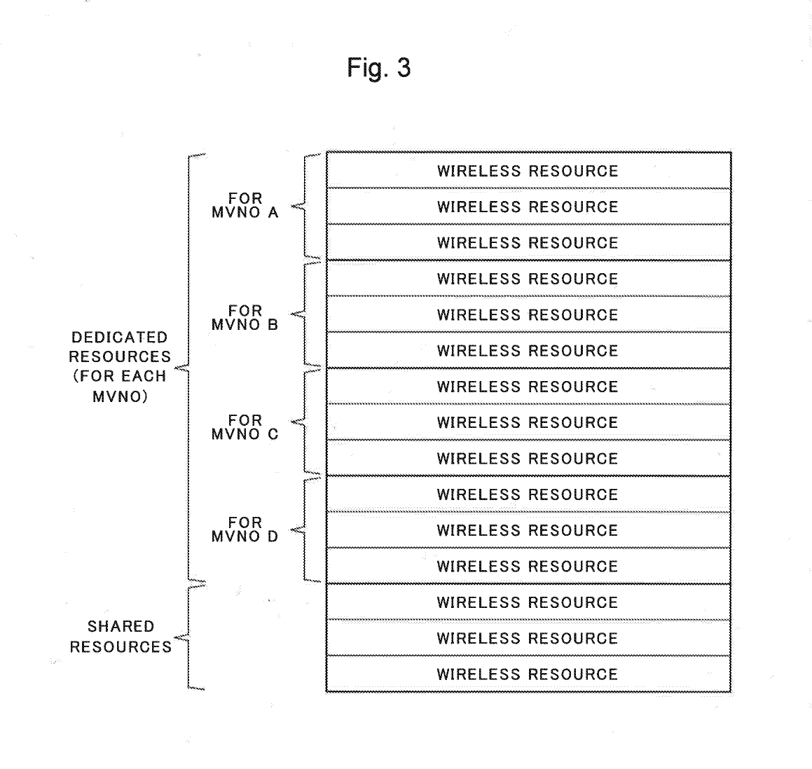

Function of the base stations 2_1 and 2_2 will be described below. Because the base stations 2_1 and 2_2 are provided with the same functions, functions of the base station 2_1 will be described representatively. FIG. 3 is a diagram showing an example of wireless resources used by the base station 2_1 in the system in the first exemplary embodiment of the present invention.

(3-1) About Wireless Resources

Similarly to a general base station, the base station 2_1 can use some number of wireless resources.

Specifically, as shown in FIG. 3, the base station 2_1 can use wireless resources dedicated to each of MVNOA, MVNOB, MVNOC and MVNOD (hereafter referred to as “dedicated resources”) and those shared by the MVNOs (hereafter referred to as “shared resources”), similarly to a general base station. The wireless resources may be frequency bands. Alternatively, when the base station 2_1 is compatible with the OFDM method, the wireless resources may be resource blocks. Further alternatively, when the base station 2_1 is compatible with the CDMA method, the wireless resources may be codes. Further, the wireless resources may be combinations of frequency bands, resource blocks and codes. OFDM mentioned above is an abbreviation of Orthogonal Frequency Division Multiplexing, and CDMA is an abbreviation of Code Division Multiple Access.

(3-2) Function to Use Wireless Resources

The base station 2_1 has a general base station function to operate in conformity with 3GPP. That is, the base station 2_1 receives a message for requesting a connection from the terminals 1_k of the MVNOs, in conformity with 3GPP.

On receiving a message for requesting a connection, the base station 2_1 communicates with the terminal 1_k by using one of the corresponding dedicated resources preferentially but, if all the dedicated resources have been used up, by using one of the shared resources instead. Here, in the case of using a dedicated resource, the base station 2_1 extracts MVNO information from the message for requesting a connection, and uses one of the dedicated resources dedicated to an MVNO indicated by the extracted MVNO information.

Through the above-described function, the dedicated and shared resources (that is, the wireless resources of the base station 2_1) are used by each MVNO.

(3-3) Function to Report a Wireless Resource Usage Status

The base station 2_1 notifies the server 4 of the amount of wireless resource usage by each MVNO at a constant time interval.

Specifically, the base station 2_1 calculates the number of wireless resources currently used for each of the MVNOs (for communicating with terminals of the MVNOs) at predetermined timing, and notifies the server 4 of the calculated numbers as the amounts of wireless resource usage by the respective MVNOs. A specific example of the calculation will be described later in “(2) operation of notifying the server 4 of a wireless resource usage status”. The predetermined timing mentioned above corresponds to a constant time interval, which is set to the base station 2_1 in advance by an administrator of the system of the present exemplary embodiment.

(3-4) Function to Enable the Use of Wireless Resources in Order from an MVNO Given a Highest Position in a Usage Priority Order (an MVNO Currently Using a Smaller Portion of all Wireless Resources)

The base station 2_1 is notified of a priority order of the MVNOs in using its shared resources (hereafter referred to as a “usage priority order”) from the server 4. The base station 2_1 enables an MVNO given a higher position in the usage priority order to preferentially use the shared resources.

Specifically, the base station 2_1 preferentially receives a connection request message from a terminal 1_k of an MVNO given a higher position in the usage priority order. On receiving the connection request message, the base station 2_1 communicates with the terminal 1_k of the MVNO given a higher position in the usage priority order by using the dedicated or shared resources, in the manner described above in “(3-2) function to use wireless resources”.

(4) Functions of the Server 4

(4-1) Calculation of a Proportion of Wireless Resource Usage by Each MVNO

The server 4 is notified of the amount of wireless resource usage by each MVNO from each of the base stations 2_1 and 2_2. Being notified of the amounts of wireless resource usage by each MVNO, the server 4 calculates a proportion of wireless resource usage by each MVNO, that is, what percentage of all wireless resources each MVNO is currently using. The “all wireless resources” means all of the wireless resources provided in the base stations 2_1 and 2_2, which are connected to the server 4.

The above-mentioned calculation is implemented, in terms of each MVNO, by the server 4 adding the amount of wireless resource usage by the MVNO notified from the base station 2_1 and that notified from the base station 2_2, and dividing the added value by the number of all wireless resources. Each of thus calculated quotients is hereafter referred to as a “proportion of wireless resource usage by the MVNO”.

The number of all wireless resources corresponds to the total of the numbers of wireless resources provided in the respective base stations 2_1 and 2_2, both connected to the server 4, which is set to the server 4 in advance by an administrator of the system of the present exemplary embodiment.

(4-2) Calculation of a Priority Order in Shared Resource Usage

On the basis of the calculated proportion of wireless resource usage by each MVNO, the server 4 determines a priority order of the MVNOs in using shared resources. The server 4 gives a higher position in the usage priority order to an MVNO of a smaller proportion of wireless resource usage, and a lower position to an MVNO of a larger proportion of wireless resource usage. It is in order to enable the MVNOs to use all wireless resources averagely each other.

The server 4 notifies each of the base stations 2_1 and 2_2 of the determined usage priority order of the MVNOs.

(5) Configuration of the Base Stations 2_1 and 2_2

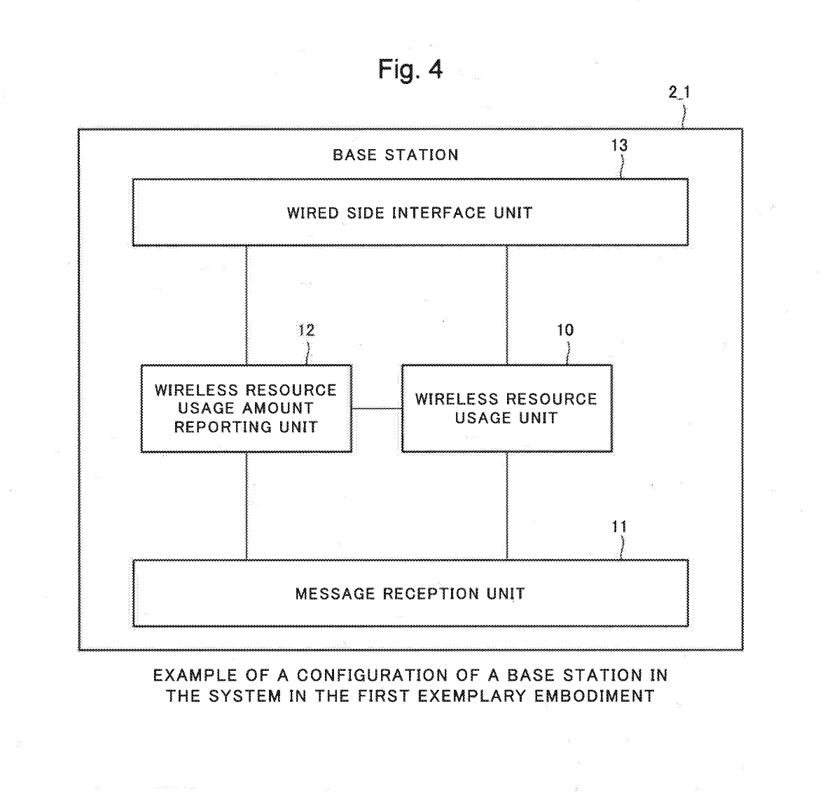

FIG. 4 is a diagram showing an example of a configuration of the base station 2_1 provided in the system in the first exemplary embodiment of the present invention.

To realize “(3) functions of the base stations 2_1 and 2_2” described above, the base station 2_1 comprises, as shown in FIG. 4, a wireless resource usage unit 10, a message reception unit 11, a wireless resource usage amount reporting unit 12 and a wired side interface unit 13. The base station 2_2 has the same configuration as that of the base station 2_1.

(6) Configuration of the Server 4

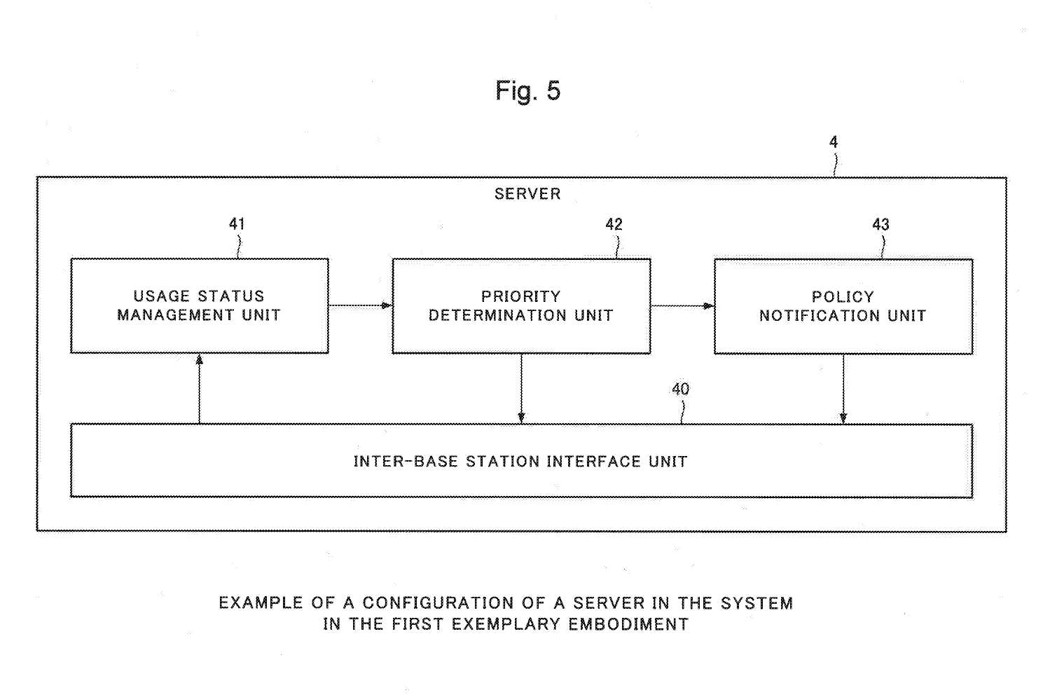

FIG. 5 is a diagram showing an example of a configuration of the server 4 provided in the system in the first exemplary embodiment of the present invention.

To realize “(4) functions of the server 4” described above, the server 4 comprises, as shown in FIG. 5, an inter-base station interface unit 40, a usage status management unit 41, a priority determination unit 42 and a policy notification unit 43.

[Description of Operation]

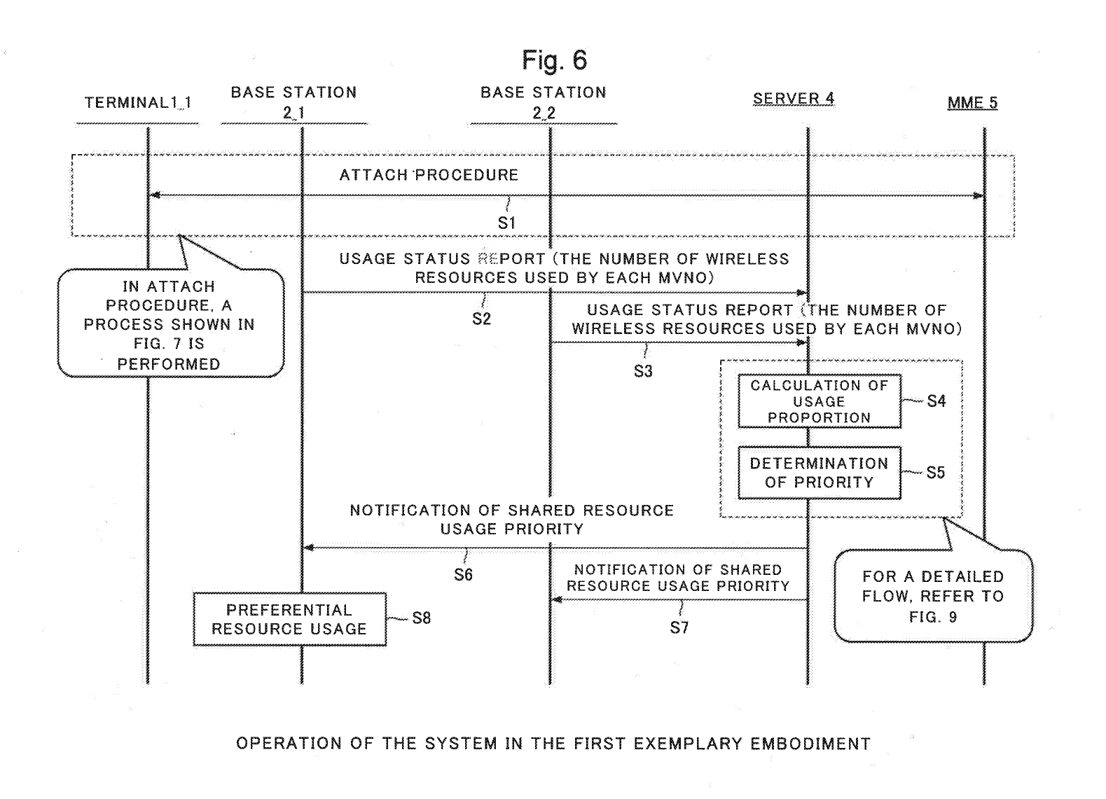

FIG. 6 is a diagram for explaining operation of the system in the first exemplary embodiment of the present invention. Using FIG. 6, detailed operation of the system of the present exemplary embodiment will be described below.

Hereinafter, a description of the terminal 1_1 will be given first and, subsequently, that of the other terminals 1_2 to 1_24 will be given.

(1) Correlating a Wireless Resource with an MVNO Using it

First, existing in the cell of the base station 2_1, the terminal 1_1 performs a general Attach procedure specified in 3GPP with the MME 5, as shown in FIG. 6 (S1).

In the above-mentioned Attach procedure, on receiving a message for requesting a connection from the terminal 1_1, the base station 2_1 communicates with the terminal 1_1 by using one of the corresponding dedicated resources preferentially but, if all the dedicated resources have been used up, by using one of the shared resources, similarly to a general base station.

At that time, the base station 2_1 acquires MVNO information from the message for requesting a connection (hereafter referred to as a “connection request message”), and correlates the acquired MVNO information with the wireless resource (the dedicated or shared resource) having been used in the communication with the terminal 1_1. It is in order to make it possible to recognize by which MVNO (its terminal) each of the wireless resources is currently used. Here, the above-mentioned MVNO information is, as described in “(2) functions of terminals 1_k (k=1 to 24)”, information indicating which MVNO the terminal 1_1 is using, that is, information indicating which MVNO's terminal the terminal 1_1 is.

(1-1) Specific Operation in S1

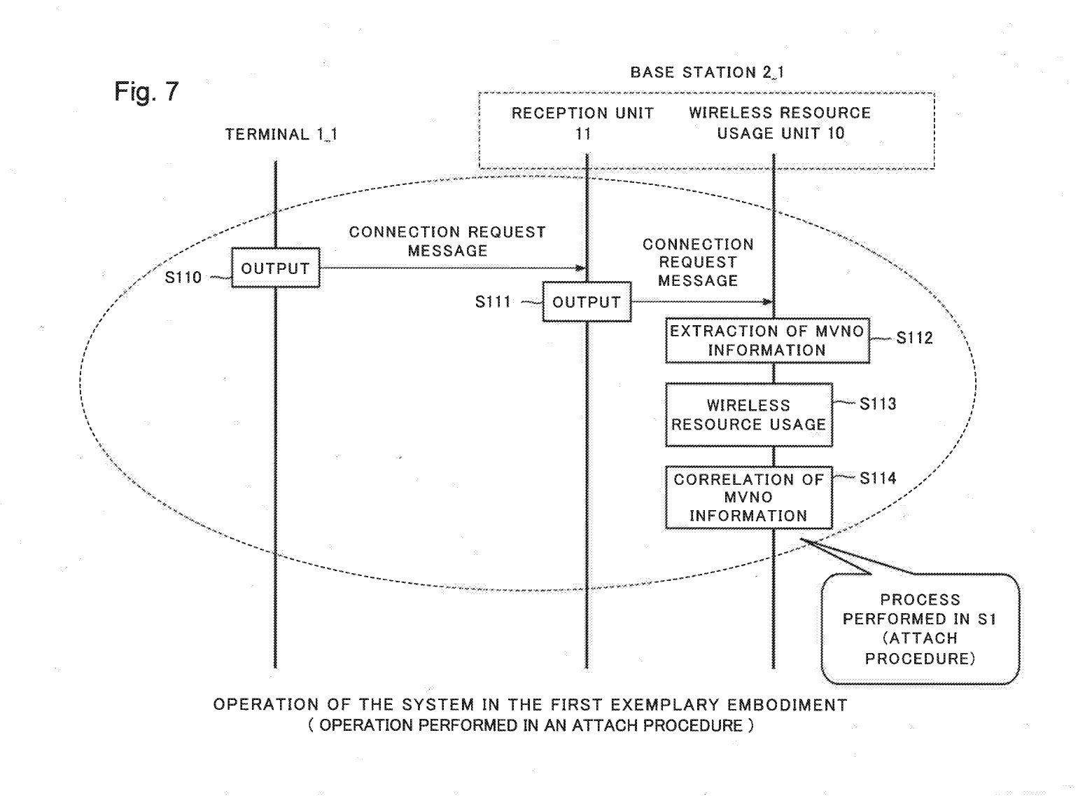

The operation in S1 described above is implemented as in steps S110 to S113 described below, by the terminal 1_1 and the wireless resource usage unit 10 of the base station 2_1. FIG. 7 is a diagram for explaining the operation (performed in the Attach procedure) of the system in the first exemplary embodiment of the present invention.

(1-2) About S110 to S113

In the general Attach procedure, as shown in FIG. 7, first, the terminal 1_1 sends a connection request message (specifically RRC Connection Request) to the base station 2_1 in whose cell it currently exists (S110).

At that time, the terminal 1_1 sends also the MVNO information written in the SIM card installed in itself, by including the MVNO information in the connection request message. It is in order to inform the base station 2_1 of which MVNO's terminal the terminal 1_1 is.

Next, receiving the connection request message from the terminal 1_1 in conformity with 3GPP, the message reception unit 11 of the base station 2_1 outputs the received connection request message to the wireless resource usage unit 10 (S111).

Then, receiving the connection request message thus inputted to it, the wireless resource usage unit 10 of the base station 2_1 extracts MVNO information from the connection request message (S112).

Then, thus extracting MVNO information, the wireless resource usage unit 10 communicates with the terminal 1_1 by using one of the dedicated resources dedicated to the MVNO indicated by the extracted MVNO information (S113).

Here, if all the dedicated resources have been used up, the wireless resource usage unit 10 communicates with the terminal 1_1 by using one of the shared resources.

Next, the wireless resource usage unit 10 correlates the MVNO information extracted in S112 described above to the wireless resource used for the communication with the terminal 1_1 (S114).

For example, the wireless resource usage unit 10 may realize the above-mentioned correlation by correlating one of predetermined numbers corresponding to the respective wireless resources (frequency bands) with the MVNO information extracted in S112. The predetermined numbers are set to the wireless resource usage unit 10 in advance by an administrator of the system of the present exemplary embodiment.

(1-3) About Other Terminals 1_2 to 1_12

While the above description has been given of the terminal 1_1, it applies also to other terminals 1_2 to 1_12. That is, if any one of the other terminals 1_2 to 1_12 exists in its cell and sends a connection request message to it, the base station 2_1 executes the steps S111 to S114 described above, similarly to the case of the terminal 1_1.

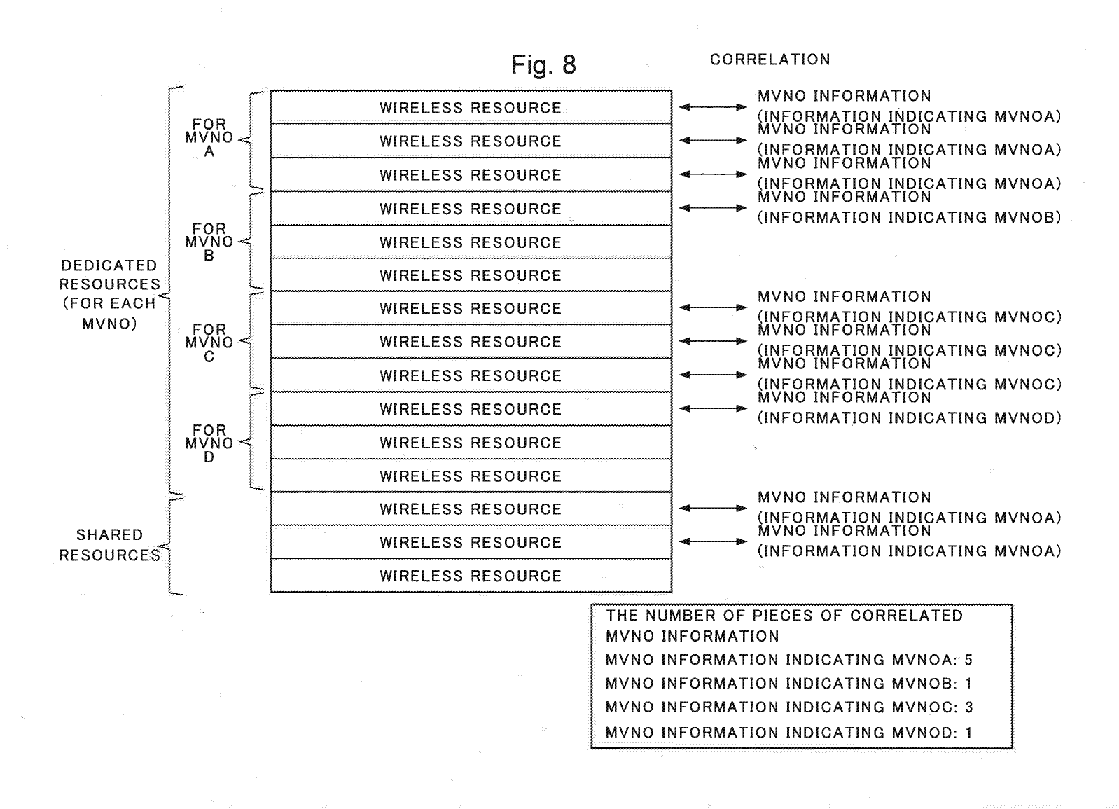

FIG. 8 is a diagram for explaining the wireless resources provided in the base station 2_1.

(1-4) Summary of the Operation in S110 to S114 (Status of Wireless Resources)

As a result of the base station 2_1 executing the above-mentioned steps S111 to S114 in terms of each of the terminals 1_1 to 1_12, pieces of MVNO information received from the terminals 1_2 to 1_12 are each correlated to a corresponding one of the wireless resources, as shown in FIG. 8.

By the above-mentioned correlation, it becomes possible to recognize by which MVNO (its terminal) each of the wireless resources is currently used.

(1-5) Alternative Operation to S112 to S114 Described Above

MVNO information may also be included in another kind of message than a connection request message (hereafter referred to as “another received message”). On receiving another received message from the terminal 1_1, the wireless resource usage unit 10 may extract MVNO information from the message and correlate the extracted MVNO information with a wireless resource having been used to communicate with the terminal 1_1, instead of S114 described above. For example, the another received message is RRC Connection Setup Complete.

(2) Operation of Notifying the Server 4 of a Wireless Resource Usage Status

(2-1) Overview of Operation

Next, as shown in FIG. 6, the base station 2_1 notifies the server 4 of the number of wireless resources used by each MVNO (hereafter referred to as “the amount of wireless resource usage by each MVNO”) (S2).

The operation in S2 described above is executed at a constant time interval.

(2-2) Specific Operation in S2

The operation in S2 described above is performed as described below, by the wireless resource usage amount reporting unit 12 (hereafter referred to as a “reporting unit 12”) and the wired side interface unit 13 of the base station 2_1.

First, at predetermined timing, the reporting unit 12 of the base station 2_1 counts, in terms of each type of MVNO information correlated with wireless resources, the number of wireless resources correlated with the MVNO information, and stores the counted number and the MVNO information being the counting target in a manner to correlate them with each other.

For example, when pieces of MVNO information are each correlated with wireless resources as in FIG. 8, the reporting unit 12 counts the number to be 5 in terms of MVNO information indicating the MVNOA, and stores the counted number 5 and the MVNO information indicating the MVNOA in a manner to correlate them with each other.

Similarly, in terms of MVNO information indicating the MVNOB, the reporting unit 12 counts the number to be 1, and stores the counted number 1 and the MVNO information indicating the MVNOB in a manner to correlate them with each other. Further, the reporting unit 12 counts the number to be 3 in terms of MVNO information indicating the MVNOC and then stores the number 3 and the MVNO information indicating the MVNOC in a manner to correlate them with each other, and also counts the number to be 1 in terms of MVNO information indicating the MVNOD and then stores the number 1 and the MVNO information indicating the MVNOD in the same manner.

Here, the predetermined timing mentioned above corresponds to a constant time interval, which is set to the reporting unit 12 in advance by an administrator of the system of the present exemplary embodiment.

Next, the reporting unit 12 outputs each of the stored numbers (hereafter referred to as “the number of used wireless resources”) and of the stored pieces of MVNO information, to the wired side interface unit 13.

Then, the wired side interface unit 13 sends the number of used wireless resources and the piece of MVNO information inputted from the reporting unit 12, to the server 4, as the amount of wireless resource usage by each MVNO.

(3) Operation of the Base Station 2_2

The base station 2_2 performs the same operation as that of the base station 2_1. As a result, similarly to the base station 2_1, the base station 2_2 notifies the server 4 of the amount of wireless resource usage by each MVNO (S3).

(4) Operation of the Server 4: Part 1 (Operation of Calculating a Proportion of Wireless Resource Usage by Each MVNO)

(4-1) Overview of Operation

Being notified of the amount of wireless resource usage by each MVNO from each of the base stations 2_1 and 2_2, the server 4 calculates a proportion of wireless resource usage by each MVNO, that is, what percentage of all wireless resources (of the system of the present exemplary embodiment) is currently used by each of the MVNOs, as shown in FIG. 6 (S4).

The “all wireless resources” mentioned above means all the wireless resources provided in the base stations 2_1 and 2_2 connected to the server 4.

(4-2) Specific Operation in S4

The operation in S4 described above is performed as in steps S140 to S142 described below, by the inter-base station interface unit 40 and the usage status management unit 41 of the server 4.

(4-2-1) about S140 to S141

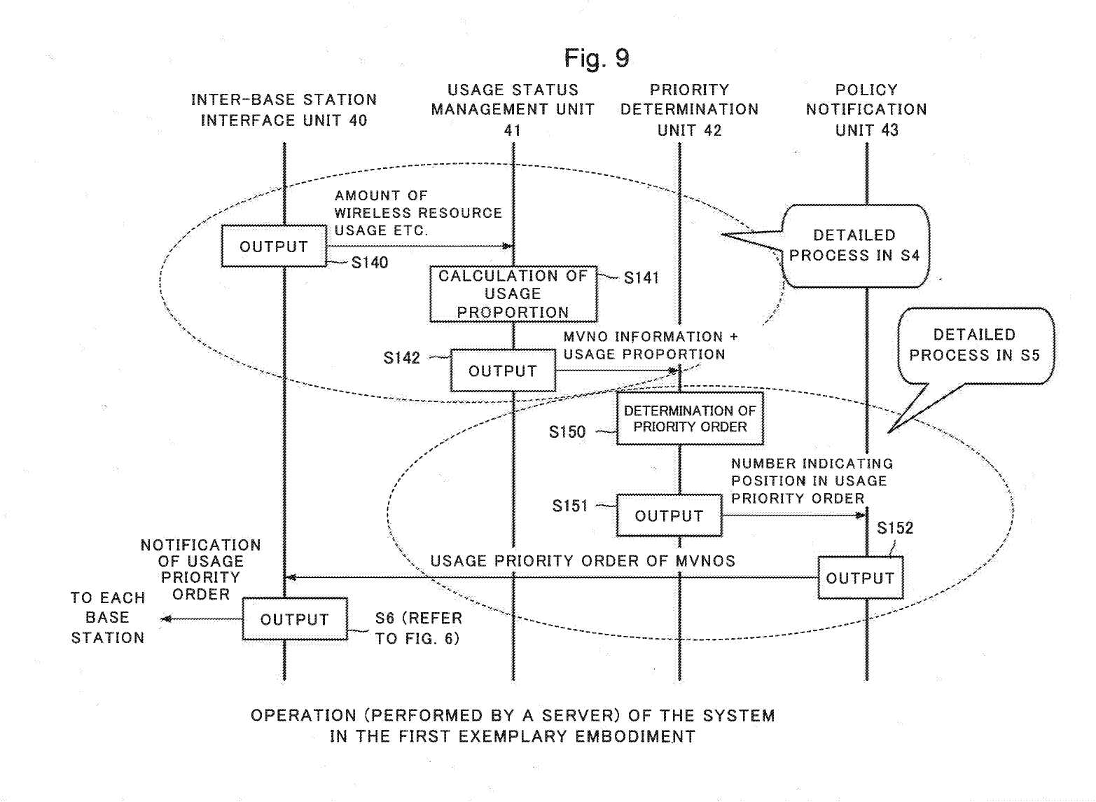

FIG. 9 is a diagram for explaining operation of the system (operation of the server) in the first exemplary embodiment of the present invention.

First, receiving the amount of wireless resource usage by each MVNO (that is, the MVNO information and the number of used wireless resources) from each of the base stations 2_1 and 2_2, the inter-base station interface unit 40 of the server 4 outputs the received information to the usage status management unit 41, as shown in FIG. 9 (S140).

At that time, the MVNO information and the number of used wireless resources, thus outputted, are correlated with each other.

Then, receiving the pieces of MVNO information and the numbers of used wireless resources inputted to it, the usage status management unit 41 calculates a proportion of wireless resource usage by each MVNO, out of all wireless resources, and stores the calculation results (S141).

Specifically, in terms of each of the pieces of MVNO information inputted to it, the usage status management unit 41 sums up all of the numbers of wireless resource usage correlated to the MVNO information, divides the sum by the number of all wireless resources, and determines a value obtained by multiplying the quotient by 100 to be the proportion of wireless resource usage by the corresponding MVNO, which is then stored in a manner to correlate it with the MVNO information.

(4-2-2) Example of the Operation in S141

For example, it is assumed that, to the usage status management unit 41 (via the inter-base station interface unit 40), MVNO information indicating the MVNOA and the number of used wireless resources equal to 5 have been inputted from the base station 2_1, and also MVNO information indicating the MVNOA and the number of used wireless resources equal to 10 from the base station 2_2.

In that case, the usage status management unit 41 sums up the numbers of used wireless resources correlated with the MVNO information indicating the MVNOA thus inputted, and divides the resultant sum value 15 (the total of the above-mentioned numbers representing the respective usage amount, 5+10) by the number of all wireless resources. The usage status management unit 41 determines a value obtained by multiplying the quotient of the division by 100 to be the proportion of wireless resource usage by the MVNOA, and stores the value in a manner to correlate it with the MVNO information indicating the MVNOA.

It is similarly assumed that, from the base station 2_1 to the usage status management unit 41 (via the inter-base station interface unit 40), the number of used wireless resources equal to 1 has been inputted in correlation with MVNO information indicating the MVNOB. The usage status management unit 41 divides the total value of the numbers of used wireless resources inputted in correlation with the MVNO information indicating the MVNOB, which becomes 1 (being equal to the above-mentioned number representing the usage amount, 1), by the number of all wireless resources. The usage status management unit 41 determines a value obtained by multiplying the quotient of the division by 100 to be the proportion of wireless resource usage by the MVNOB, and stores the value in a manner to correlate it with the MVNO information indicating the MVNOB.

The number of all wireless resources mentioned above is the total value of the numbers of wireless resources of the respective base stations 2_1 and 2_2 connected to the server 4, and is set to the server 4 in advance by an administrator of the system of the present exemplary embodiment.

(4-2-3) about S142

Next, the usage status management unit 41 outputs the proportion of wireless resource usage by each MVNO and the MVNO information stored in S141 described above to the priority determination unit 42 (S142).

(4-3) Summary of S140 to S142 (Example of Operation Result)

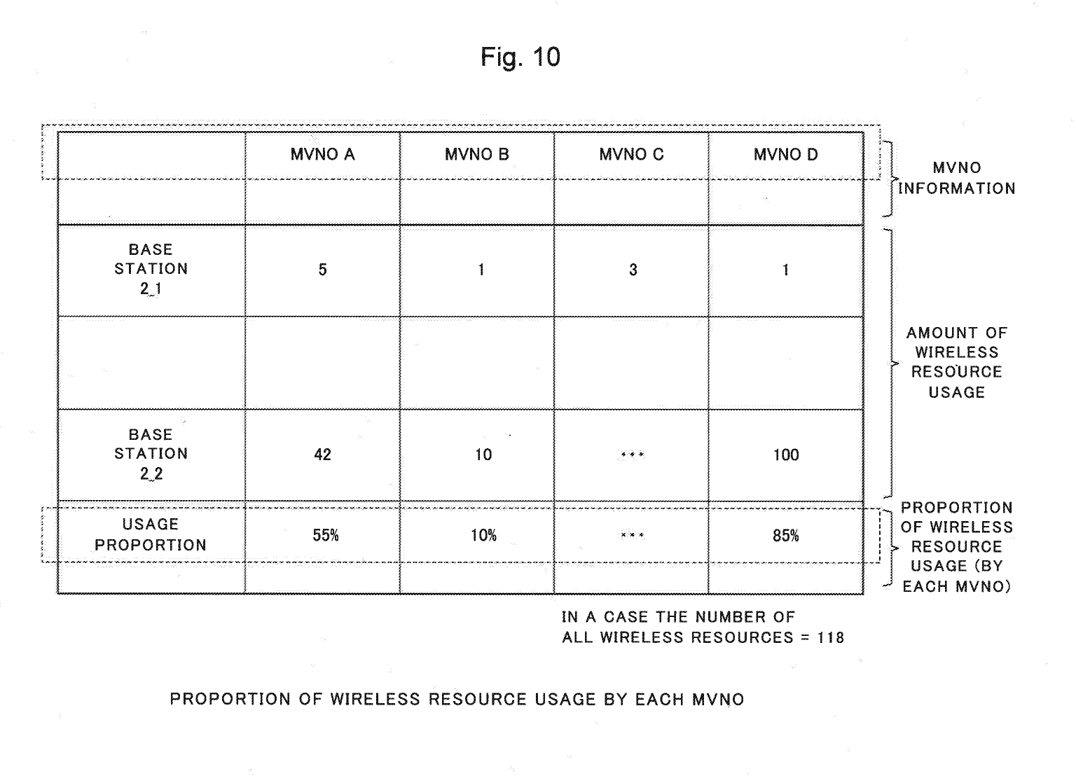

FIG. 10 is a diagram showing an example of the proportion of wireless resource usage by each MVNO stored in the server 4.

As a result of executing the steps S140 to S142 described above, the usage status management unit 41 stores the proportion of wireless resource usage by each MVNO and the corresponding MVNO information in a manner to correlate them with each other, as in portions of FIG. 10 each enclosed by a dashed line, and outputs them to the priority determination unit 42. Here, the usage status management unit 41 may store also the amount of wireless resource usage by each MVNO (that is, the MVNO information and the number of used wireless resources) received in S140 described above, additionally.

(4-4) Alternative Operation in S141

While it has been described that, in S141 described above, the usage status management unit 41 divides the total value of the numbers of used wireless resources by the number of all wireless resources, the division does not necessarily need to be performed. It is because a process of steps S150 to S152 described later (calculation of a priority order of the MVNOs) is not influenced by that. In the case of not performing the division, in S141, the usage status management unit 41 stores the total value of the numbers of used wireless resources, as it is, in a manner to correlate it with the corresponding MVNO information. It is further assumed that, in S142 subsequent to S141, the usage status management unit 41 regards the above total value as the proportion of wireless resource usage by the MVNO, and outputs the value to the priority determination unit 42 in a manner to correlate it with the corresponding MVNO information.

(5) Operation of the Server 4: Part 2 (Operation of Determining a Priority Order of MVNOs in Shared Resource Usage)

(5-1) Overview of Operation

Next, as shown in FIG. 6, the server 4 determines a priority order of the MVNOs in shared resource usage, on the basis of the proportion of wireless resource usage by each of the MVNOs calculated in S4 described above (S5).

At that time, in order to enable the MVNOs to use all wireless resources averagely each other, the server 4 determines the usage priority order in a manner to give a higher position in the usage priority order to an MVNO of a smaller proportion of wireless resource usage, and a lower position to an MVNO of a larger proportion of wireless resource usage,

(5-2) Specific Operation in S5

The above-described operation in S5 is implemented by the priority determination unit 42 and the policy notification unit 43 of the server 4, as in steps S150 to S152 described below.

(5-2-1) about S150 to S152

First, as shown in FIG. 9, on receiving the proportion of wireless resource usage by each MVNO and the pieces of MVNO information inputted to it, the priority determination unit 42 of the server 4 determines, in terms of each of the pieces of inputted MVNO information, the proportion of wireless resource usage, as it is, to be a number indicating the position in the usage priority order (S150).

(5-2-2) Example of Operation in S150

For example, it is assumed that, to the priority determination unit 42 of the server 4, MVNO information indicating the MVNOA and a value of 55(%) as the correlated proportion of wireless resource usage, as well as MVNO information indicating the MVNOB and a value of 10(%) as the correlated proportion of wireless resource usage, have been inputted.

For the MVNO information indicating the MVNOA, the priority determination unit 42 of the server 4 determines a number indicating the position in the usage priority order to be 55. The number 55 indicating the position in the usage priority order represents the 55th place. Similarly, for the MVNO information indicating the MVNOB, the priority determination unit 42 of the server 4 determines a number indicating the position in the usage priority order to be 10. The number 10 indicating the position in the usage priority order represents the 10th place.

The priority determination unit 42 of the server 4 obtains a larger number indicating a position in the usage priority order (that is, a lower position in the usage priority order) when the proportion of wireless resource usage is larger. Here, the priority determination unit 42 of the server 4 may consider, as a number indicating a position in the usage priority order, any kind of number which is in a monotonically increasing relation with the inputted proportion of wireless resource usage.

(5-2-3) about Operation after S150

Next, as shown in FIG. 9, subsequently to S150 described above, the priority determination unit 42 of the server 4 outputs the number indicating a position in the usage priority order which has been obtained for each of the pieces of MVNO information, in a manner to correlate it with the MVNO information, to the policy notification unit 43 (S151).

For example, to the policy notification unit 43, the priority determination unit 42 of the server 4 outputs the MVNO information indicating the MVNOA and the number 55 (55th) indicating the position of the MVNOA in the usage priority order, in a manner to correlate them with each other, and also outputs the MVNO information indicating the MVNOB and the number 10 (10th) indicating the position of the MVNOB in the usage priority order, in a manner to correlate them with each other.

Next, as shown in FIG. 9, the policy notification unit 43 of the server 4 outputs, to the inter-base station interface unit 40, the pieces of MVNO information and the numbers each indicating a position in the usage priority order, which have been inputted from the priority determination unit 42, in a manner to correlate them with each other, as the usage priority order of the MVNOs (S152).

(5-2-4) Summary of S150 to S152 (Example of Operation Result)

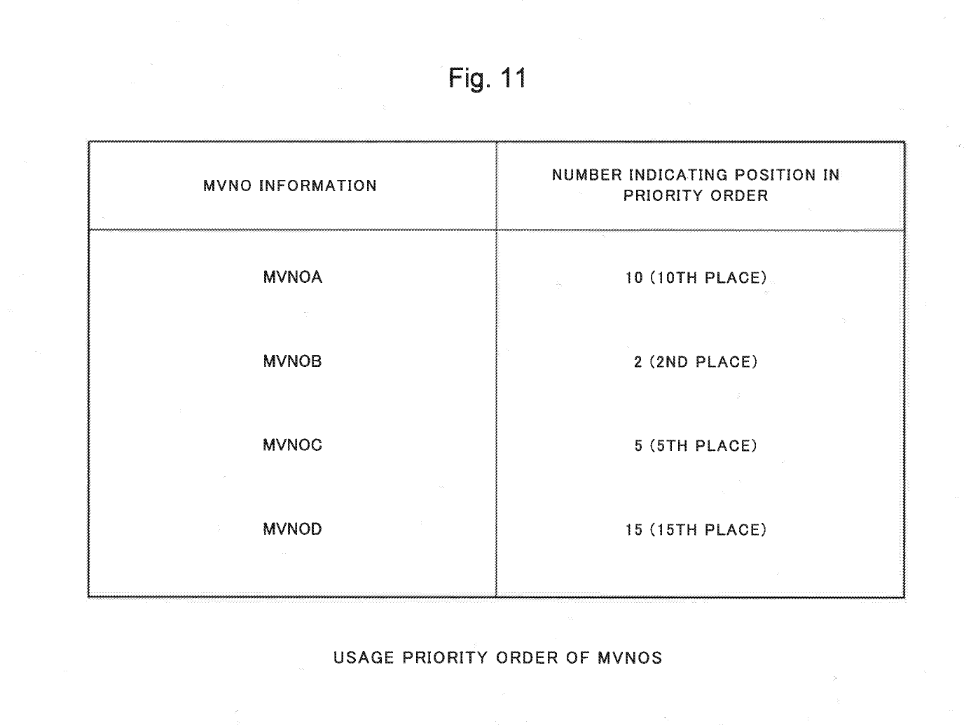

FIG. 11 is a diagram showing an example of a usage priority order of the MVNOs outputted from the policy notification unit 43 of the server 4. In such a manner of correlating each of the pieces of MVNO information with one of the numbers each indicating a position in the usage priority order as shown in FIG. 11, for example, the usage status management unit 41 may output them to the policy notification unit 43.

(6) Operation of the Server 4 (Operation of Notifying Each Base Station of the Usage Priority Order of the MVNOs)

Next, as shown in FIG. 6, subsequently to S5 (S150 to S152) described above, the server 4 notifies each of the base stations 2_1 and 2_2 of the usage priority order of the MVNOs (S6, S7).

Specifically, the inter-base station interface unit 40 of the server 4 sends the pieces of MVNO information and the numbers each indicating a position in the usage priority order, which have been inputted from the policy notification unit 43, to each of the base stations 2_1 and 2_2.

(7) Operation of Each Base Station (Operation of Enabling an MVNO Given a Higher Position in the Usage Priority Order to Preferentially Use Shared Resources)

(7-1) Overview of Operation

Next, as shown in FIG. 6, being notified of the usage priority order of the MVNOs from the server 4, each of the base stations 2_1 and 2_2 enables an MVNO given a higher position in the usage priority order to preferentially use the shared resources (S8).

Specifically, the base station 2_1 and 2_2 each preferentially receive a connection request message from a terminal 1_k of an MVNO given a higher position in the usage priority order. On its receiving a connection request message, each of the base stations 2_1 and 2_2 executes the above-described steps S110 to S114, and accordingly communicates with a terminal 1_k of an MVNO given a higher position in the usage priority order, by using a dedicated or shared resource.

(7-2) Specific Operation in S8

The step S8 described above is implemented by the wireless resource usage unit 10 provided in each of the base stations 2_1 and 2_2 executing steps S170 to S182 described below. Here, while operation performed in the base station 2_1 will be described representatively in steps S170 to S182 described below, the same operation is performed also in the base station 2_2.

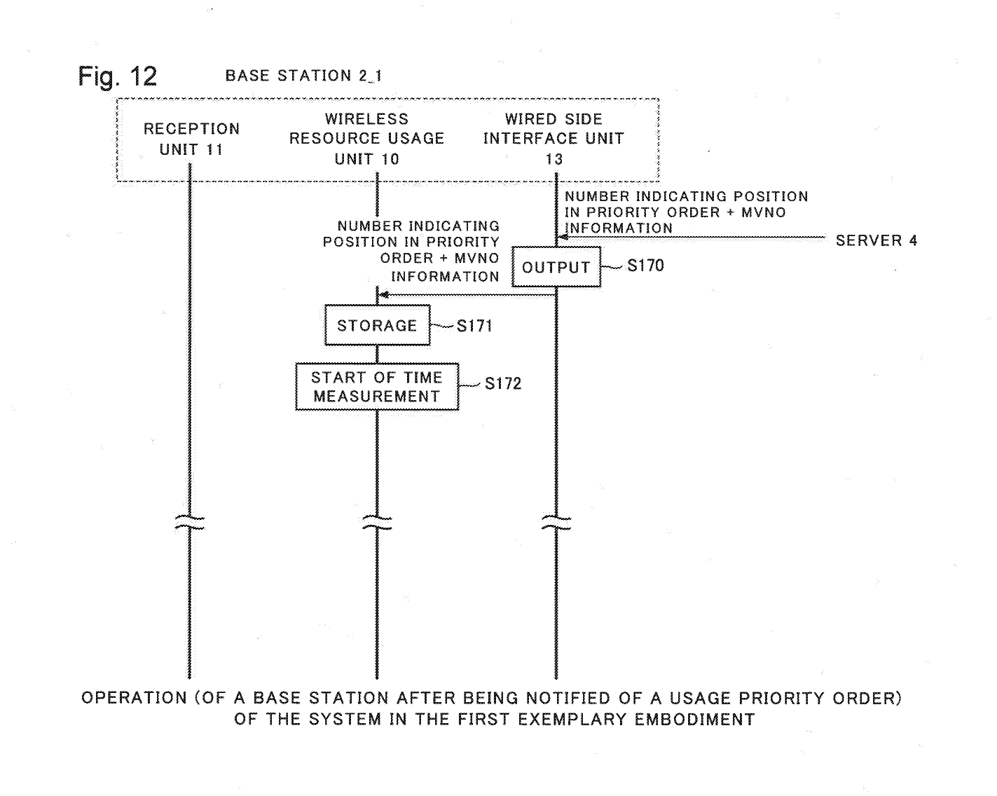

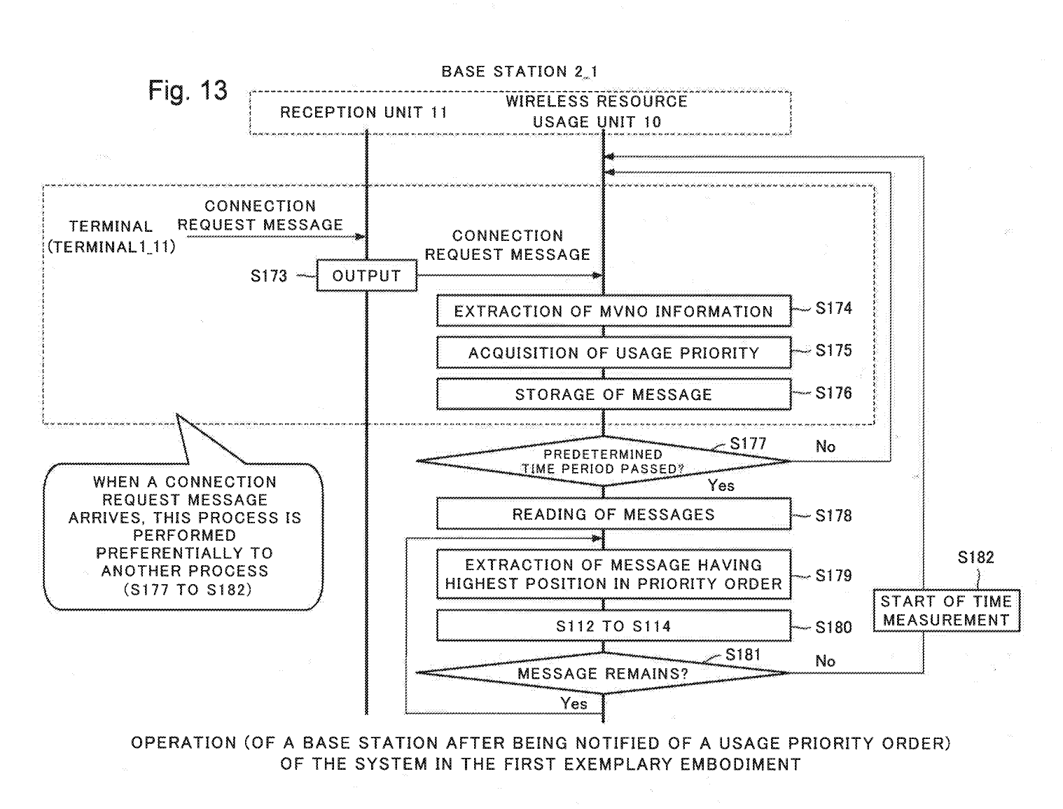

FIGS. 12 and 13 are diagrams for explaining operation of the system in the first exemplary embodiment of the present invention (operation of the base stations after being notified of the usage priority order).

(7-2-1) about S170 to S182

(7-2-1-1) Operation of Storing the Usage Priority Order

First, as shown in FIG. 12, receiving the pieces of MVNO information and the numbers each indicating a position in the usage priority order from the server 4, the wired side interface unit 13 of the base station 2_1 outputs them to the wireless resource usage unit 10 (S170).

Then, the wireless resource usage unit 10 of the base station 2_1 correlates the inputted pieces of MVNO information and positions in the usage priority order with each other, and stores the correlation result as a priority order management table (S171).

Next, the wireless resource usage unit 10 of the base station 2_1 starts up its own timer function, thereby starting a time measurement (S172).

It is in order to enable determination (in S177 described later) of whether or not a predetermined time period has passed since S172 described above.

(7-2-1-2) Operation of Storing Connection Request Messages Received During a Certain Time Period into a Memory

It is assumed that, after the steps S170 to S172 described above, the base station 2_1 receives a connection request message from a terminal (for example, the terminal 1_11) existing in its own cell.

As shown in FIG. 13, on receiving the connection request message from the terminal 1_11, the message reception unit 11 of the base station 2_1 outputs the received connection request message to the wireless resource usage unit 10, similarly to in S111 described above (S173).

Then, receiving the connection request message inputted from the message reception unit 11, the wireless resource usage unit 10 of the base station 2_1 extracts MVNO information from the inputted connection request message, similarly to in S112 described above (S174).

Then, the wireless resource usage unit 10 acquires the degree of usage priority for an MVNO indicated by the extracted MVNO information (S175).

Specifically, the wireless resource usage unit 10 reads the priority order management table and, from the priority order management table, acquires a number indicating a position in the usage priority order correlated with the MVNO information extracted in S174 described above.

Then, the wireless resource usage unit 10 temporarily stores the received connection request message and the number indicating a position in the usage priority order acquired in S175 described above, in a manner to correlate them with each other, into its own memory (hereafter referred to as a “reception buffer”) (S176).

Next, the wireless resource usage unit 10 determines whether or not a time period measured by the timer function (started up in S172 described above) has exceeded a predetermined time period (S177).

The predetermined time period is set to the wireless resource usage unit 10 by an administrator of the system of the present exemplary embodiment.

If the measured time period has not exceeded the predetermined one yet (if NO at S177), the wireless resource usage unit 10 repeats the steps S174 to S176 described above until the measured time period exceeds the predetermined one. That is, when receiving another connection request message from any other terminal, the wireless resource usage unit 10 stores the connection request message and a number indicating a position in the usage priority order, in a manner to correlate them with each other, into the reception buffer.

In the reception buffer, some number of connection request messages each correlated with a number indicating a position in the usage priority order are thus accumulated.

After that, if the measured time period has exceeded the predetermined one (if YES at S177), the wireless resource usage unit 10 extracts all connection request messages having been accumulated in the reception buffer, and temporarily stores them into its another own memory (hereafter referred to as a “processing memory”) (S178).

It is in order to process the messages accumulated in the reception buffer before the above predetermined time period passes.

Next, from among the connection request messages stored in the processing memory, the wireless resource usage unit 10 extracts one connection request message to which a highest position in the usage priority order (that is, a smallest number indicating a position in the usage priority order) is correlated (S179).

Hereinafter, the present description will be continued assuming that the connection request message extracted in S179 is the one received from the terminal 1_11. Here, it is assumed that, if any connection request message is inputted during a time period since the determination at S177 has become YES until executing S182 described later, the wireless resource usage unit 10 preferentially executes the steps S174 to S176 described above (the process enclosed by a dashed line in FIG. 13). That is, it is assumed that, if any connection request message is inputted, the wireless resource usage unit 10 stores the message into the reception buffer (in a manner to correlate it with a number indicating a position in the usage priority order).

Next, subsequently to S179 described above, regarding the connection request message extracted in S179 as a received connection request message, the wireless resource usage unit 10 executes the steps S112 to S114 described above (S180).

As a result, the wireless resource usage unit 10 communicates with the terminal 1_11 of the MVNO given the highest position in the usage priority order, by using a dedicated or shared resource.

Next, the wireless resource usage unit 10 determines whether or not any other connection request messages are stored in the processing memory (S181).

If any other connection request message is stored in the processing memory (if YES at S181), the wireless resource usage unit 10 returns to S179 described above, and thereby extracts a connection request message corresponding to a next highest position in the usage priority order from the processing memory. Then, on the extracted connection request message, the wireless resource usage unit 10 executes the steps S180 to S181 described above.

As a result, the wireless resource usage unit 10 executes the steps S112 to S114 described above on the connection request messages in descending order of the position in the usage priority order correlated to each of the connection request messages. As a result of the execution of the steps S112 to S114, the wireless resource usage unit 10 communicates with a terminal of an MVNO given a higher position in the usage priority order, among terminals each having sent a connection request message, by using a dedicated or shared resource.

Here, if both the dedicated resources and the shared resources have already been used up, the wireless resource usage unit 10 cannot execute the steps S112 to S114 described above, and accordingly cannot communicate with the terminal. In that case, the wireless resource usage unit 10 stores the connection request message extracted in S179 described above, again into the reception buffer. It is in order to wait for a free shared resource to process the connection request message and to process in the next predetermined time period.

When storing a connection request message into the reception buffer, the wireless resource usage unit 10 may perform the storage in a manner to correlate 1 to the connection request message, as a storage cycle number. After that, each time storing the connection request message again into the reception buffer, the wireless resource usage unit 10 may perform the storage with the storage cycle number being incremented. The wireless resource usage unit 10 may delete a message to which a storage cycle number equal to or larger than a certain number is correlated, from the reception buffer. It is in order to avoid that a connection request message correlated with a low position in the usage priority order is indefinitely stored in the reception buffer.

Next, if no connection request message is stored in the processing memory mentioned above (if NO at S181), the wireless resource usage unit 10 once stops and then starts up again the timer function, thereby starting a new time measurement (S182).

After that, if any connection request message is inputted, the wireless resource usage unit 10 stores the inputted connection request message into the reception buffer after executing the steps S174 to S177 described above and, while performing those operations, waits until the predetermined time period passes again. When the predetermined time period has passed, the wireless resource usage unit 10 executes the steps S178 to S182 described above and, after that, repeatedly executes the steps S174 to S182.

(7-3) Operation when, Afterwards, Numbers Indicating a Usage Priority Order is Inputted to the Base Stations from the Server 4

(7-3-1) about Operation of the Server 4

As already described above in S2 and S3, from each of the base station 2_1 and 2_2 to the server 4, the amount of wireless resource usage is repeatedly notified at a constant interval. Each time notified of the amounts of wireless resource usage from each of the base station 2_1 and 2_2, the server 4 executes the steps S4 to S7 described above, and accordingly, it repeatedly sends numbers indicating a usage priority order and pieces of MVNO information to each of the base station 2_1 and 2_2.

As a result, to the wireless resource usage unit 10 of each of the base stations 2_1 and 2_2, numbers indicating a usage priority order and pieces of MVNO information are repeatedly inputted from the server 4 (via the wired side interface unit 13), in parallel but asynchronously with execution of the steps S174 to S182.

(7-3-2) Operation of the Base Stations when Numbers Indicating a Usage Priority Order are Inputted from the Server 4

On receiving numbers indicating a usage priority order and pieces of MVNO information inputted from the server 4, the wireless resource usage unit 10 of each of the base stations 2_1 and 2_2 executes the steps S170 to S172. That is, the wireless resource usage unit 10 correlates the inputted numbers indicating a usage priority order with the inputted pieces of MVNO information, and stores the correlation result as a new priority order management table. At that time, the wireless resource usage unit 10 updates a priority order management table having been stored until that time, by overwriting it with the new priority order management table. This process is executed preferentially compared to that of the steps S174 to S182.

The new priority order management table is used since the next time the wireless resource usage unit 10 executes the steps S174 to S182. That is, when executing the steps S174 to S182 the next time and later, the wireless resource usage unit 10 uses the new priority order management table, and accordingly performs communication with terminals, by using the dedicated or shared resources in order from a terminal of an MVNO given a highest position in the usage priority order represented by the new management table.

(7-4) Result of Operation in S170 to S182

As a result of executing the steps S170 to S182 described above, the wireless resources, including the shared resources, of each of the base stations 2_1 and 2_2 are used by the MVNOs (their terminals) in order from an MVNO given a highest position in the usage priority order. That is, the wireless resources of each of the base stations 2_1 and 2_2 are used by the MVNOs (their terminals) in order from an MVNO currently using a smallest proportion of all wireless resources. Because, thus, an MVNO currently with a lower proportion of wireless resource usage uses the wireless resources more preferentially, the MVNOs can use the wireless resources more fairly.

(7-5) Process which May be Executed after Storing a New Priority Order Management Table

Here, when executing S178 described above for the first time after storing a new priority order management table in S171 described above, the wireless resource usage unit 10 may perform a process of steps (I) to (III) described below. That is, when executing S178 for the first time after storing a new priority order management table, the wireless resource usage unit 10 may execute the steps (I) to (III) described below on each connection request message extracted from the reception buffer. It thereby becomes possible to surely correlate, to a connection request message to be stored into the process memory in S178, a number indicating a latest corresponding position in the usage priority order given in the new priority order management table.

(I) First, similarly to in S174 described above, the wireless resource usage unit 10 extracts MVNO information from the connection request message.

(II) Next, similarly to in S175 described above, the wireless resource usage unit 10 acquires, from the new priority order management table, a number indicating a position in the usage priority order correlated with the extracted MVNO information.

(III) Next, the wireless resource usage unit 10 replaces a number indicating a position in a usage priority order already correlated to the connection request message with the number indicating a position in the usage priority order acquired in (II), and then stores the connection request message into the processing memory.

The wireless resource usage unit 10 executes the above steps (I) to (III) on each and every connection request message extracted from the reception buffer.

The operations having been described hereinbefore are the primary ones of the system of the present exemplary embodiment.

Other examples of modified operation will be described below in (7-6) and (7-7). The system of the present exemplary embodiment may operate also as in (7-6) and (7-7) described below.

(7-6) Alternative Operation of the Base Stations (Concerning a Value Notified to the Server 4)

In S2 described above, the reporting unit 12 of each of the base stations 2_1 and 2_2 notifies the server 4 of the number of used wireless resources along with the corresponding MVNO information.

Instead of the number of used wireless resources, the reporting unit 12 may notify the server 4 of a value obtained by dividing the number of used wireless resources by the number of wireless resources provided in the base station and then multiplying the quotient by 100 (hereafter referred to as a “proportion of wireless resource usage in base station”).

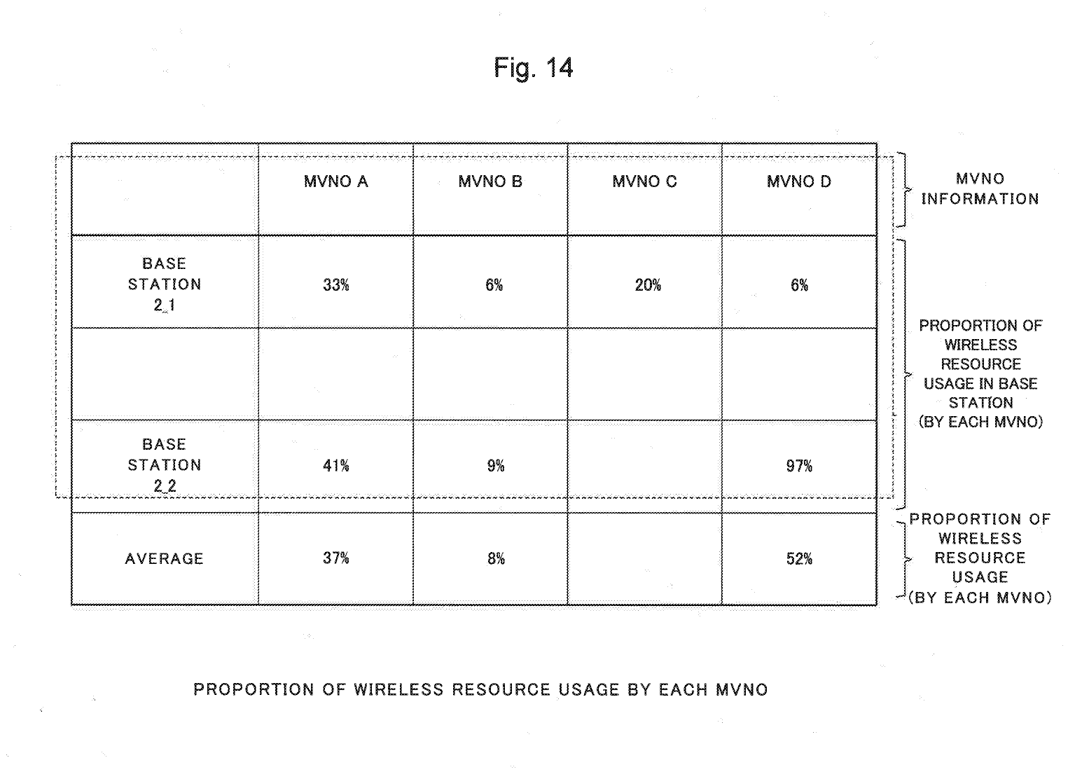

In that case, the server 4 uses the above-mentioned “proportion of wireless resource usage in base station” as a substitute for the number of used wireless resources. Further, the server 4 may store MVNO information and a proportion of wireless resource usage in base station which are received in S140 described above, in a manner to correlate them with each other as shown inside a dashed square in FIG. 14. FIG. 14 is a diagram showing examples of MVNO information and a proportion of wireless resource usage stored in the server 4.

(7-7) Alternative Operation of the Server (Concerning Calculation of a Proportion of Usage in all Wireless Resources)

In the process of S141 described above, the usage status management unit 41 divides the total value of the numbers of used wireless resources by the number of all wireless resources. Instead of dividing by the number of all wireless resources, the usage status management unit 41 may divide the total value of the numbers of used wireless resources by the number of dedicated resources. The number of dedicated resources is set to the usage status management unit 41 in advance by an administrator of the system of the present exemplary embodiment.

### Description of the Effect

According to the present exemplary embodiment, MVNOs can share wireless resources of each base station more fairly.

It is because the system of the present exemplary embodiment finds an MVNO currently using a smaller proportion of wireless resources provided in the base stations (that is, an MVNO of a smaller usage amount) and accordingly enables the MVNO to preferentially use the wireless resources.

### Second Exemplary Embodiment

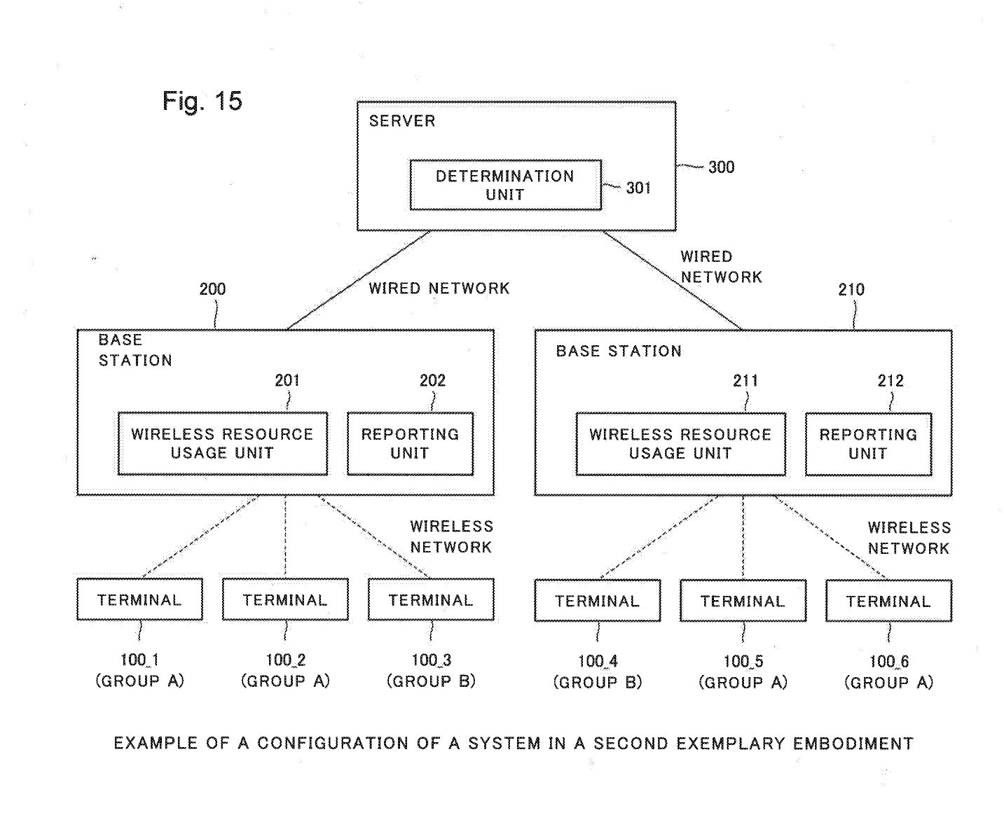

FIG. 15 is a diagram showing an example of a configuration of a system in a second exemplary embodiment of the present invention. Hereinafter, configuration and operation of the system of the second exemplary embodiment will be described.

[Description of Configuration]

(1) Configuration of the System of the Second Exemplary Embodiment

As shown in FIG. 15, the system of the second exemplary embodiment comprises terminals 100_1 to 100_6, base stations 200 and 210, and a server 300.

The base station 200 is connected with the terminals 100_1 to 100_3 via a wireless network, and the base station 210 is connected with the terminals 100_4 to 100_6 via a wireless network. The base stations 200 and 210 are connected with the server 300 via a wired network.

(2) Configuration of the Base Stations 200 and 210

The base station 200 comprises a wireless resource usage unit 201 and a reporting unit 202. The base station 210 comprises a wireless resource usage unit 211 and a reporting unit 212.

(3) Configuration of the Server 300

The server 300 comprises a determination unit 301, as shown in FIG. 15.

(4) About the Terminals 100_1 to 100_6

The terminals 100_1 to 100_6 each are a terminal of a predetermined group. The predetermined group may be a predetermined mobile virtual network operator.

Hereinafter, the present description will be continued assuming that, as shown in FIG. 15, the terminals 100_1, 100_2, 100_5 and 100_6 are terminals of a group A, and the terminals 100_3 and 100_4 are terminals of a group B.

(5) About Wireless Resources

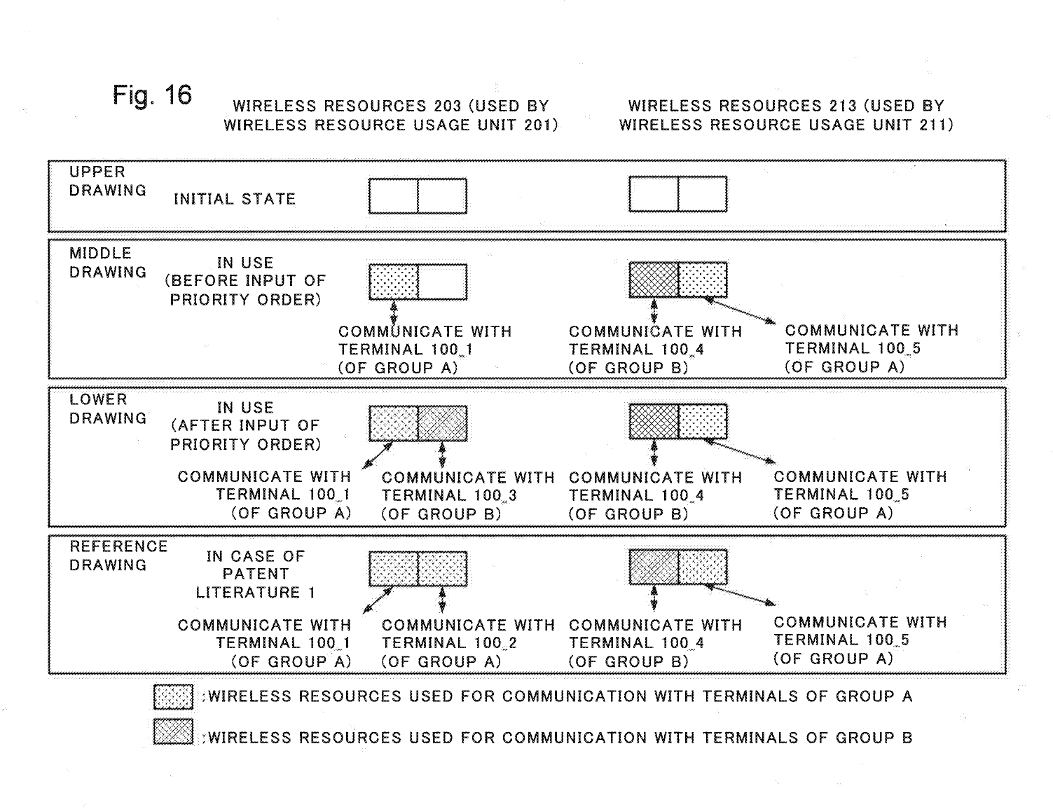

FIG. 16 is a diagram for explaining wireless resources used by the base stations of the system in the second exemplary embodiment of the present invention.

As shown in the upper drawing in FIG. 16, the wireless resource usage unit 201 of the base station 200 may use two wireless resources to communicate with the terminals 100_1 to 100_3. In FIG. 16, the two wireless resources used by the wireless resource usage unit 201 are denoted as wireless resources 203. The wireless resources are frequency bands. Similarly, the wireless resource usage unit 211 of the base station 210 may use two wireless resources (that is, two frequency bands) to communicate with the terminals 100_4 to 100_6. In FIG. 16, the two wireless resources used by the wireless resource usage unit 211 are denoted as wireless resources 213.

[Description of Operation]

Next, a description will be given of operation of the system of the present exemplary embodiment.

(1) Operation of the Base Stations 200 and 210

(1-1) Operation of the Base Stations 200 and 210 for Wireless Resource Usage

First, on its receiving a connection request message from a terminal of the predetermined group A or B, each of the wireless resource usage units 201 and 211 of the respective base stations 200 and 210 communicates with the terminal by using the wireless resources 203 and 213, respectively.

For example, on receiving a connection request message from the terminal 100_1 of the group A, the wireless resource usage unit 201 of the base station 200 communicates with the terminal 100_1 of the group A, by using one of the wireless resources 203, as shown in the middle drawing in FIG. 16. Similarly, on receiving a connection request message from each of the terminals 100_4 and 100_5, of the respective groups B and A, the wireless resource usage unit 211 of the base station 210 communicates with the terminals 100_4 and 100_5, by using one of the wireless resources 213 for each of the terminals.

(1-2) Operation of the Base Stations 200 and 210 for Reporting a Wireless Resource Usage Status

Next, at predetermined timing, each of the reporting units 202 and 212 of the respective base stations 200 and 210 outputs, in terms of each of the groups, the amount of wireless resource usage for communication with terminals of the group.

For example, at predetermined timing, the reporting unit 212 of the base station 210 outputs the usage amount of the wireless resources 213 (one resource) for communication with terminals of the group A (specifically, only the terminal 100_5), to the server 300. As shown in the middle drawing in FIG. 16, the number of the wireless resources 213 used for communication with terminals of the group A is one. The reporting unit 212 of the base station 210 outputs also the usage amount of the wireless resources 213 (one resource) for communication with terminals of the group B (specifically, only the terminal 100_4), to the server 300.

Similarly, at predetermined timing, the reporting unit 202 of the base station 200 outputs the usage amount of the wireless resources 203 (one resource) for communication with terminals of the group A (specifically, only the terminal 100_1), to the server 300.

(1-2-3) about the Predetermined Timing

The predetermined timing mentioned above corresponds to a constant time interval, which is set to the reporting units 202 and 212 of the respective base stations 200 and 210 in advance by an administrator of the system of the present exemplary embodiment.

(2) Operation of the Server 300

### (2-1) Operation of the Server 300

As a result of the base station operation described above in (1-2), to the determination unit 301 of the server 300 from at least either of the base stations 200 and 201 connected to the server 300, the amount of wireless resource usage related to each of the groups A and B is inputted.

The determination unit 301 of the server 300 outputs, in terms of each of the groups A and B, information corresponding to a predetermined number which is in a monotonically increasing relation with the total of the amounts of wireless resource usage (related to the group), as information indicating a position of the group in a priority order.

### (2-2) Specific Example

(2-2-1) about the Amount of Wireless Resource Usage to be Inputted

For example, to the server 300 from the base station 200, the amount of wireless resource usage related to the group A (one resource) is inputted.

Similarly, to the server 300 from the base station 210, the amount of wireless resource usage related to the group A (one resource) is inputted, and that related to the group B (one resource) is also inputted. In that case, the total amount of wireless resource usage related to the group A is two resources, and that related to the group B is one resource.

(2-2-2) an Example of Operation of the Server 300, and Concerning a Priority Order

The determination unit 301 of the server 300 may output a predetermined number 100 (100th) corresponding to the total amount of wireless resource usage equal to two resources (as information indicating the position of the group A in the priority order), to each of the base stations 200 and 210. Similarly, the determination unit 301 of the server 300 may output a predetermined number 1 (1st) corresponding to the total amount of wireless resource usage equal to one resource (as information indicating the position of the group B in the priority order), to each of the base stations 200 and 210.

The total amount of wireless resource usage and the predetermined number are in a monotonically increasing relation with each other. That is, the predetermined number becomes larger when the total amount of wireless resource usage is larger. The predetermined numbers are set to the determination unit 301 of the server 300 in advance, in a manner to be correlated with values of the total amount of wireless resource usage, by an administrator of the system of the present exemplary embodiment.

(3) Operation of the Base Stations 200 and 210 after Input of a Priority Order

### (3-1) Operation of the Base Stations 200 and 210 after Input of a Priority Order

To the wireless resource usage units 201 and 211 of the respective base stations 200 and 210, information indicating a priority order of the groups is inputted from the determination unit 301 of the server 300, in response to the output of the amounts of usage.

Receiving the information indicating a priority order of the groups inputted to them, when communicating with the terminals after that, each of the wireless resource usage units 201 and 211 of the respective base stations 200 and 210 performs the communication with the terminals by using its wireless resources in order from the terminal of the group having a highest position in the priority order indicated by the inputted information.

### (3-2) Specific Example

For example, it is assumed that, to the wireless resource usage unit 201 of the base station 200, a number 100 (100th) is inputted as information indicating the position of the group A in the priority order, and a number 1 (1st) is inputted as information indicating the position of the group B in the priority order. The smaller the inputted number is, the higher the position in the priority order is.

When communicating with the terminals 100_2 and 100_3 of the respective groups A and B, the wireless resource usage unit 201 of the base station 200 performs the communication with the terminals by using the wireless resources 203 in order from the terminal 100_3 of the group B whose position in the priority order indicated by the inputted information (number) is higher.

As a result, as shown in the lower drawing in FIG. 16, the wireless resources 203 are used for communication with the terminals 100_1 and 100_3.

(4) Summary of Operation

(4-1) Summary of Operation of the System of the Present Exemplary Embodiment

As a result of the above-described operation, out of the total of four wireless resources provided in the system of the present exemplary embodiment, two are used for communication with the terminals of the group A, and two are used for communication with the terminals B of the group B, as shown in the lower drawing in FIG. 16.

That is, the group A (for example, a mobile virtual network operator A) comes to use two wireless resources, and the group B (for example, a mobile virtual network operator B) also does two wireless resources. As a result, the groups A and B (for example, the mobile virtual network operators A and B) can use the wireless resources provided in the system of the present exemplary embodiment fairly.

(4-2) Comparison with the Mobile Communication System of PTL 1

In the mobile communication system of PTL 1, no priority order is inputted and, therefore, communication with the terminals is performed by using the wireless resources unfavorably in order from the terminal 100_2 of the group A. As a result, as shown in a reference drawing in FIG. 16, three of all wireless resources provided in the system of the present exemplary embodiment are used for performing communication with terminals of the group A, and resultantly, the group A (the mobile virtual network operator A) dominantly uses the wireless resources. Thus, in the mobile communication system of PTL 1, the groups A and B (the mobile virtual network operators A and B) cannot use the wireless resources fairly.

(5) About Wireless Resources

While the number of wireless resources (frequency bands) used by each of the wireless resource usage units 201 and 211 has been assumed to be two in the above description, the number may be other than two. The wireless resource usage units 201 and 211 each may use more than two wireless resources (frequency bands).

Further, while the above description has been given assuming the wireless resources to be frequency bands, the wireless resources may be frequency bands, resource blocks or codes, or their combinations.

### Description of the Effect

According to the present exemplary embodiment, MVNOs (mobile virtual network operators) can share wireless resources of base stations more fairly.

It is because the system of the present exemplary embodiment enables an MVNO currently using a smaller portion of wireless resources of base stations to preferentially use the wireless resources.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2014-131961 filed on Jun. 27, 2014, the disclosure of which is incorporated herein in its entirety by reference.

The whole or part of the exemplary embodiments disclosed above can be described as, but not limited to, the following supplementary notes.

### (Supplementary Note 1)

A base station comprising:

a wireless resource usage means for, on receiving a connection request message from a terminal of one of predetermined groups, performing communication with the terminal by using wireless resources for communication; and

a reporting means for, at predetermined timing, outputting, in terms of each of the groups, the usage amount of the wireless resources used for performing communication with terminals of the group, wherein

if information indicating a priority order of the groups is inputted to the wireless resource usage means in response to the output, when communicating with the terminals after that, the wireless resource usage means performs the communication with the terminals by using the wireless resources in order from the terminal of the group having a highest position in the priority order indicated by the information.

### (Supplementary Note 2)

The base station according to Supplementary Note 1, wherein:

the wireless resource usage means correlates each of the used wireless resources with an identifier indicating a group related to the terminal using the wireless resource; and

at the predetermined timing, the reporting means outputs, in terms of each of the identifiers, the usage amount corresponding to the number of wireless resources correlated to the identifier, in a manner to correlate the usage amount with the identifier.

### (Supplementary Note 3)

The base station according to Supplementary Note 2, wherein the wireless resource usage means extracts the identifier from a predetermined message received from the terminal.

### (Supplementary Note 4)

The base station according to any one of Supplementary Notes 1 to 3, wherein the predetermined groups are predetermined mobile virtual network operators.

### (Supplementary Note 5)

A server comprising

a determination means for, on receiving the amount of wireless resource usage related to each predetermined group inputted from at least one of base stations connected to the server, outputting, in terms of each of the groups, information corresponding to a predetermined number which is in a monotonically increasing relation with the total of the amounts of wireless resource usage related to the group, as information indicating a position of the group in a priority order.

### (Supplementary Note 6)

The server according to Supplementary Note 5, further comprising

a management means for, in terms of each identifier indicating the group which is inputted from each of the base stations, outputting a first value corresponding to the total of the amounts of wireless resource usage inputted in correlation to the identifier, in a manner to correlate the first value with the identifier, wherein

the determination means outputs, in terms of each of the identifiers inputted from the management means, the information corresponding to the predetermined number which is in a monotonically increasing relation with the first value correlated with the identifier.

### (Supplementary Note 7)

The server according to Supplementary Note 6, wherein

the first value is a value obtained by dividing the total of the amounts of wireless resource usage by the number of all wireless resources provided in the base stations connected with the server.

### (Supplementary Note 8)

A system comprising a base station and a server connected with each other, wherein:

the base station is the base station according to any one of Supplementary Notes 1 to 4; and

the server is the server according to any one of Supplementary Notes 5 to 7.

### (Supplementary Note 9)

A wireless resource usage method comprising:

on receiving the amount of wireless resource usage related to each predetermined group inputted from at least one of base stations, outputting, in terms of each of the groups, information corresponding to a predetermined number which is in a monotonically increasing relation with the total of the amounts of wireless resource usage related to the group, as information indicating a position of the group in a priority order; and

when communicating with terminals of the groups, each of the base stations performing the communication with the terminals by using its wireless resources in order from the terminal of the group having a highest position in the priority order indicated by the inputted information.

### (Supplementary Note 10)

The wireless resource usage method according to Supplementary Note 9, wherein

at predetermined timing, in terms of each group, the amounts of wireless resource usage for communication with terminals of the group are outputted.

### (Supplementary Note 11)

The base station according to any one of Supplementary Notes 1 to 4, wherein the wireless resources are frequency bands, resource blocks or codes, or their combinations.

### (Supplementary Note 12)

The base station according to Supplementary Note 3, 4 or 11, wherein

the predetermined message is RRC (Radio Resource Control) Connection Request or RRC Connection Setup Complete specified in 3GPP (3rd Generation Partnership Project).

### REFERENCE SIGNS LIST

1_1 to 1_24, 100_1 to 100_6 terminal
2_1, 2_2, 200, 210 base station
3 IP network
4, 300 server
5 MME
10, 201, 211 wireless resource usage unit
11 message reception unit
12 wireless resource usage amount reporting unit
13 wired side interface unit
40 inter-base station interface unit
41 usage status management unit
42 priority determination unit
202, 212 reporting unit
203, 213 wireless resources
301 determination unit

What is claimed is:

1. A base station comprising:
a wireless resource usage unit for, on receiving a connection request message from a terminal of one of predetermined groups, performing communication with the terminal by using wireless resources for communication; and
a reporting unit for, at predetermined timing, outputting, in terms of each of the groups, the usage amount of the wireless resources used for performing communication with terminals of the group, wherein
if information indicating a priority order of the groups is inputted to the wireless resource usage unit in response to the output, when communicating with the terminals after that, the wireless resource usage unit performs the communication with the terminals by using the wireless resources in order from the terminal of the group having a highest position in the priority order indicated by the information.

2. The base station according to claim 1, wherein:
the wireless resource usage unit correlates each of the used wireless resources with an identifier indicating a group related to the terminal using the wireless resource; and
at the predetermined timing, the reporting unit outputs, in terms of each of the identifiers, the usage amount corresponding to the number of wireless resources correlated to the identifier, in a manner to correlate the usage amount with the identifier.

3. The base station according to claim 2, wherein
the wireless resource usage unit extracts the identifier from a predetermined message received from the terminal.

4. The base station according to claim 1, wherein the predetermined groups are predetermined mobile virtual network operators.

5. A server comprising
a determination unit for, on receiving the amount of wireless resource usage related to each predetermined group inputted from at least one of base stations connected to the server, outputting, in terms of each of the groups, information corresponding to a predetermined number which is in a monotonically increasing relation with the total of the amounts of wireless resource usage related to the group, as information indicating a position of the group in a priority order.

6. The server according to claim 5, further comprising
a management unit for, in terms of each identifier indicating the group which is inputted from each of the base stations, outputting a first value corresponding to the total of the amounts of wireless resource usage inputted in correlation to the identifier, in a manner to correlate the first value with the identifier, wherein
the determination unit outputs, in terms of each of the identifiers inputted from the management unit, the information corresponding to the predetermined number which is in a monotonically increasing relation with the first value correlated with the identifier.

7. The server according to claim 6, wherein
the first value is a value obtained by dividing the total of the amounts of wireless resource usage by the number of all wireless resources provided in the base stations connected with the server.

8. A system comprising a base station and a server connected with each other, wherein:
the base station is the base station according to claim 1; and
the server is the server comprising
a determination unit for, on receiving the amount of wireless resource usage related to each predetermined group inputted from at least one of base stations connected to the server, outputting, in terms of each of the groups, information corresponding to a predetermined number which is in a monotonically increasing relation with the total of the amounts of wireless resource usage related to the group, as information indicating a position of the group in a priority order.

9. A wireless resource usage method comprising:
on receiving the amount of wireless resource usage related to each predetermined group inputted from at least one of base stations, outputting, in terms of each of the groups, information corresponding to a predetermined number which is in a monotonically increasing relation with the total of the amounts of wireless resource usage related to the group, as information indicating a position of the group in a priority order; and
when communicating with terminals of the groups, each of the base stations performing the communication with the terminals by using its wireless resources in order from the terminal of the group having a highest position in the priority order indicated by the inputted information.

10. The wireless resource usage method according to claim 9, wherein
at predetermined timing, in terms of each group, the amounts of wireless resource usage for communication with terminals of the group are outputted.

11. The base station according to claim 1, wherein the wireless resources are frequency bands, resource blocks or codes, or their combinations.

12. The base station according to claim 3, wherein
the predetermined message is RRC (Radio Resource Control) Connection Request or RRC Connection Setup Complete specified in 3GPP (3rd Generation Partnership Project).
